(19) United States
(12) Patent Application Publication
(10) Pub. No.: US 2024/0231736 A1
(43) Pub. Date: Jul. 11, 2024

(54) SIGNAL PROCESSING DEVICE, SIGNAL PROCESSING METHOD, AND DISPLAY SYSTEM

(71) Applicant: Sony Semiconductor Solutions Corporation, Kanagawa (JP)

(72) Inventor: Takumi Ozawa, Kanagawa (JP)

(21) Appl. No.: 18/254,781

(22) PCT Filed: Nov. 19, 2021
(86) PCT No.: PCT/JP2021/042532

§ 371 Date: May 26, 2023

(30) Foreign Application Priority Data
Dec. 2, 2020 (JP) 2020-200254

(51) Int. Cl. G06F 3/14

(52) U.S. Cl. CPC G06F 3/1446

(57) ABSTRACT

The present disclosure relates to a signal processing device, a signal processing method, and a display system capable of implementing a multi-display wall system in which display timings are synchronized while suppressing input-output delays.

The timing control unit performs control so as to advance start timings of some pieces of processing to be executed on an image signal input for displaying one image by a plurality of display devices, and controls a start timing of first processing on the image signal on the basis of a timing at which second processing executed immediately before the first processing ends in all the display devices. The technology according to the present disclosure can be applied to, for example, a panel constituting a multi-display wall system.

### TECHNICAL FIELD

The present disclosure relates to a signal processing device, a signal processing method, and a display system, and more particularly relates to a signal processing device, a signal processing method, and a display system that enable implementation of a multi-display wall system in which display timings are synchronized while suppressing input-output delays.

### BACKGROUND ART

Conventionally, a technology for matching display timings of images in a plurality of display devices is known.

For example, Patent Document 1 discloses a video signal output device that synchronizes timings at which respective output devices display a video on the basis of a time difference between a time needed for video signal processing and a time needed for audio signal processing by each of a plurality of output devices.

### CITATION LIST

### Patent Document

Patent Document 1: Japanese Patent Application Laid-Open No. 2020-36178

### SUMMARY OF THE INVENTION

### Problems to be Solved by the Invention

However, in the configuration of Patent Document 1, the timings at which the respective output devices display the video are synchronized by delaying a video signal and an audio signal input to each of the output devices.

The present disclosure has been made in view of such a situation, and enables implementation of a multi-display wall system in which display timings are synchronized while suppressing input-output delays.

### Solutions to Problems

A signal processing device of the present disclosure is a signal processing device including a timing control unit that performs control so as to advance start timings of some pieces of processing to be executed on an image signal input for displaying one image by a plurality of display devices, in which the timing control unit controls a start timing of first processing on the image signal on the basis of a timing at which second processing executed immediately before the first processing ends in all the display devices.

A signal processing method of the present disclosure is a signal processing method including, by a signal processing device, performing control so as to advance start timings of some pieces of processing to be executed on an image signal input for displaying one image by a plurality of display devices, and controlling a start timing of first processing on the image signal on the basis of a timing at which second processing executed immediately before the first processing ends in all the display devices.

A display system of the present disclosure is a display system including a plurality of display devices, in which each of the display devices includes a timing control unit that performs control so as to advance start timings of some pieces of processing to be executed on an image signal input for displaying one image by a plurality of display devices, and the timing control unit controls a start timing of first processing on the image signal on the basis of a timing at which second processing executed immediately before the first processing ends in all the display devices.

In the present disclosure, control is performed so as to advance start timings of some pieces of processing to be executed on an image signal input for displaying one image by a plurality of display devices, and a start timing of first processing on the image signal is controlled on the basis of a timing at which second processing executed immediately before the first processing ends in all the display devices.

### BRIEF DESCRIPTION OF DRAWINGS

FIG. 1 is a diagram describing an input-output delay.

FIG. 2 is a diagram describing reduction of the input-output delay.

FIG. 3 is a diagram describing reduction of the input-output delay.

FIG. 4 is a block diagram illustrating a configuration example of a multi-display wall system.

FIG. 5 is a diagram describing input of an image signal.

FIG. 6 is a diagram illustrating an example of timings of respective pieces of processing executed in each panel.

FIG. 7 is a diagram illustrating an example of an output image.

FIG. 8 is a diagram illustrating an example of timings of respective pieces of processing executed in each panel.

FIG. 9 is a diagram illustrating an example of the output image.

FIG. 10 is a block diagram illustrating a configuration example of a panel.

FIG. 11 is a diagram illustrating a connection configuration of the panel.

FIG. 12 is a diagram illustrating an example of timings of respective pieces of processing executed in each panel.

FIG. 13 is a diagram illustrating an example of timings of respective pieces of processing executed in each panel.

FIG. 14 is a diagram illustrating an example of timings of respective pieces of processing executed in each panel.

FIG. 15 is a diagram illustrating an example of timings of respective pieces of processing executed in each panel.

FIG. 16 is a diagram illustrating an example of timings of respective pieces of processing executed in each panel.

FIG. 17 is a diagram illustrating an example of timings of respective pieces of processing executed in each panel.

FIG. 18 is a block diagram illustrating a configuration example of a multi-display wall system.

FIG. 19 is a block diagram illustrating a configuration example of the panel.

### MODE FOR CARRYING OUT THE INVENTION

Hereinafter, modes for carrying out the present disclosure (hereinafter referred to as embodiments) will be described. Note that the description will be made in the following order.
1. Outline of technology according to present disclosure
2. Input-output delays and reduction thereof
3. Multi-display wall system
4. Object of present disclosure
5. Configuration of panel to which technology according to present disclosure is applied
6. Example of timings of respective pieces of processing executed in each panel
7. Modification

### <1. Overview of Technology According to Present Disclosure>

A multi-display wall system that displays one image by a plurality of display devices is known. In such a display system, a fixed delay time is set as an input-output delay of each display device in order to synchronize display timings while each display device performs image processing for high image quality.

On the other hand, for example, in cursor operation of a mouse, operation of a racing game, a fighting game, a shooting game, and the like, it is demanded to enhance responsiveness by suppressing the input-output delay as much as possible.

On the other hand, there is a technology for dynamically adjusting the input-output delay by adaptively changing start timings of software tasks in the display devices.

In a case where such technology is applied to a multi-display wall system, there is a possibility that the display timings of the respective display devices are scattered due to a difference in the processing amount in each of the display devices, a delay at the time of distributing the image signal, and the like.

Accordingly, it is necessary to synchronize the display timings of all the display devices.

Thus, in the technology according to the present disclosure, a display system capable of synchronizing the display timings of the respective display devices while dynamically adjusting input-output delays is achieved.

### <2. Input-Output Delay and Reduction Thereof>

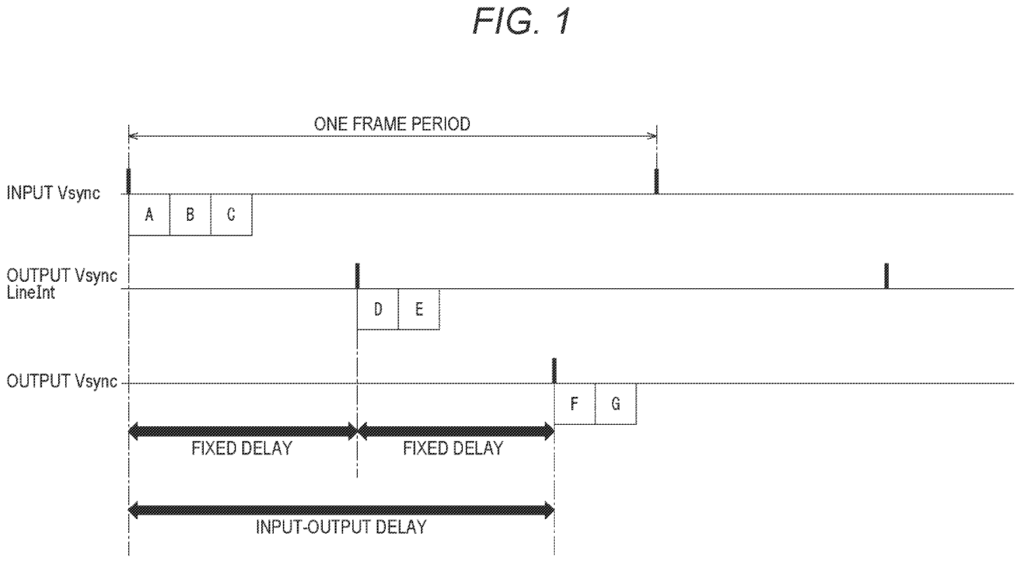

FIG. 1 is a diagram illustrating timings of respective pieces of processing executed on an image signal in a conventional display device.

FIG. 1 illustrates processing executed on an image signal in a period corresponding to one frame (one frame period).

Specifically, first, tasks A, B, and C are executed as preprocessing for an input image signal. The tasks A, B, and C are started at timings based on a vertical synchronization signal for input (input Vsync).

Next, tasks D and E are executed as setting processing for output processing of the image signal. The tasks D and E are started at timings based on a vertical synchronization interrupt signal (output VsyncLineInt).

Then, tasks F and G are executed as image signal output processing. The tasks F and G are started at timings based on a vertical synchronization signal for output (output Vsync). Here, since the input Vsync may be interrupted, different vertical synchronization signals are used for input and output in order not to interrupt output of the image signal even in such a case.

Here, processing times needed for the preprocessing (also referred to as an input task), the setting processing (also referred to as an interrupt task), and the output processing (also referred to as an output task) are not necessarily the same for each frame depending on the use case.

That is, a task in the input task varies depending on the situation, and the end timing of the input task is not necessarily the same in each frame. Thus, the length of a fixed delay is sufficiently set so that the end timing of the input task does not come after the start timing of the interrupt task.

Similarly, a task in the interrupt task varies depending on the situation, and the end timing of the interrupt task is not necessarily the same in each frame. Thus, the length of a fixed delay is sufficiently set so that the end timing of the interrupt task does not come after the start timing of the output task.

Consequently, even in a use case with few tasks, a time obtained by combining the two fixed delays occurs as an input-output delay.

Accordingly, in the technology according to the present disclosure, control for advancing the start timing of the interrupt task and the output task is implemented.

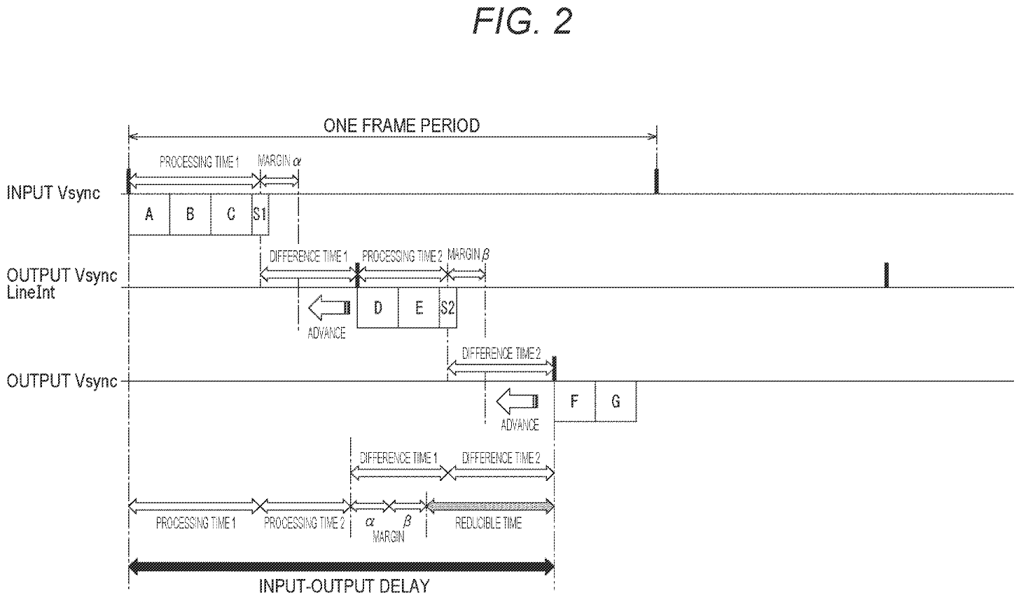

For example, as illustrated in FIG. 2, a necessary time of the input tasks (tasks A, B, and C) is set to a processing time 1, and a necessary time of the interrupt tasks (tasks D and E) is set to a processing time 2.

Furthermore, the time from the end timing of the input task to the start timing of the interrupt task is defined as a difference time 1, and the time from the end timing of the interrupt task to the start timings of the output tasks (tasks F and G) is defined as a difference time 2. Note that the end timing of the input task is detected by execution of the measurement task S1, and the end timing of the interrupt task is detected by execution of the measurement task S2.

In this case, the input-output delay due to the fixed delay described with reference to FIG. 1 is equal to the total of the processing time 1, the processing time 2, the difference time 1, and the difference time 2.

Here, as illustrated in FIG. 2, if the start timing of the interrupt task and the start timing of the output task can be advanced, the input-output delay can be reduced. At this time, the length of the difference time 1 is the maximum length of the time during which the start timing of the interrupt task can be advanced, and the length of the difference time 2 is the maximum length of the time during which the start timing of the output task can be advanced. That is, the input-output delay can be reduced by a time obtained by combining the difference time 1 and the difference time 2.

However, it is also conceivable that an unexpected task occurs in the input task, and the end timing of the input task is delayed than assumed. Accordingly, it is preferable to provide a margin α and make the length of the time for advancing the start timing of the interrupt task shorter than the length of the difference time 1.

Similarly, it is also conceivable that an unexpected task occurs in the interrupt task and the end timing of the interrupt task is delayed than assumed. Accordingly, it is preferable to provide a margin β and make the length of the time for advancing the start timing of the output task shorter than the length of the difference time 2.

Thus, a time obtained by subtracting a time obtained by combining the margin a and the margin D from a time obtained by combining the difference time 1 and the difference time 2 is a reducible time by which the input-output delay can be reduced.

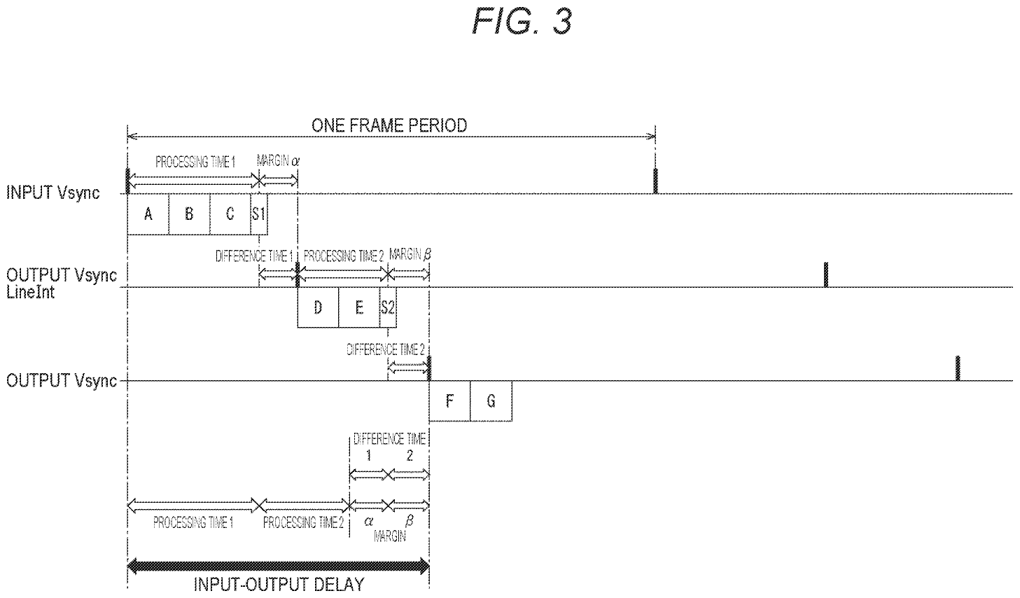

That is, as illustrated in FIG. 3, the start timing of the interrupt task is advanced so that the difference time 1 becomes equal to the margin α, and the start timing of the output task is advanced so that the difference time 2 becomes equal to the margin β. As a result, the input-output delay can be reduced by the reducible time.

### <3. Multi-Display Wall System>

As one of means for implementing appreciation of video content by a very large screen, there is a display system using a huge display. However, in such a display system, manufacturing cost of a large panel is high, and restrictions on loading and installation are also increased.

On the other hand, a multi-display wall system using a plurality of panels (display devices) has been proposed.

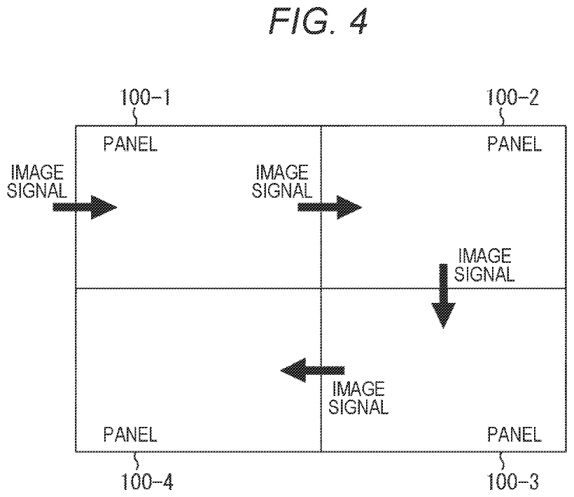

FIG. 4 is a block diagram illustrating a configuration example of the multi-display wall system.

In the multi-display wall system of FIG. 4, four panels 100-1 to 100-4 are arranged two vertically×two horizontally to constitute one huge display.

The panels 100-1 to 100-4 are connected in a row (connected in a daisy chain), and the image signal is transmitted (distributed) to the panel 100-1, the panel 100-2, the panel 100-3, and the panel 100-4 in this order.

Since such a multi-display wall system can be designed by a combination of small panels, manufacturing cost can be kept low, size flexibility is high, and restrictions on loading and installation can be reduced.

### <4. Object of Present Disclosure>

An object of the present disclosure is to reduce an input-output delay in a plurality of panels constituting a multi-display wall system.

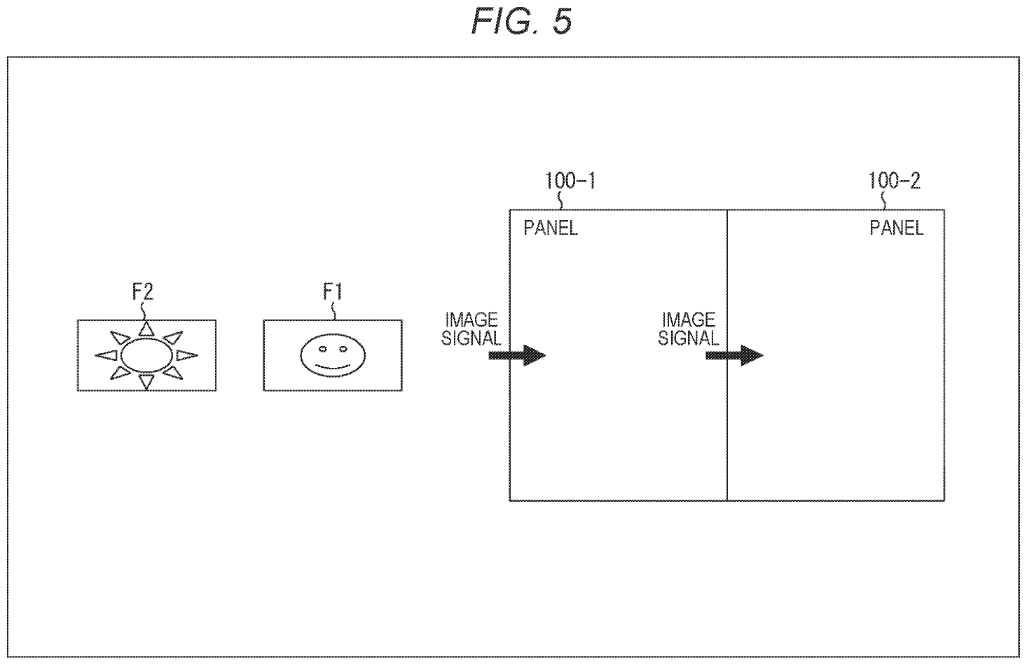

Here, a case where an image signal is input to a multi-display wall system including two panels 100-1 and 100-2 as illustrated in FIG. 5 will be described as an example. In the example of FIG. 5, an image F1 is input in a certain frame period, and an image F2 is input in the next frame period. The image F1 and the image F2 are different images.

In the configuration illustrated in FIG. 5, left halves of the image F1 and the image F2 are displayed on the panel 100-1, and right halves of the image F1 and the image F2 are displayed on the panel 100-2.

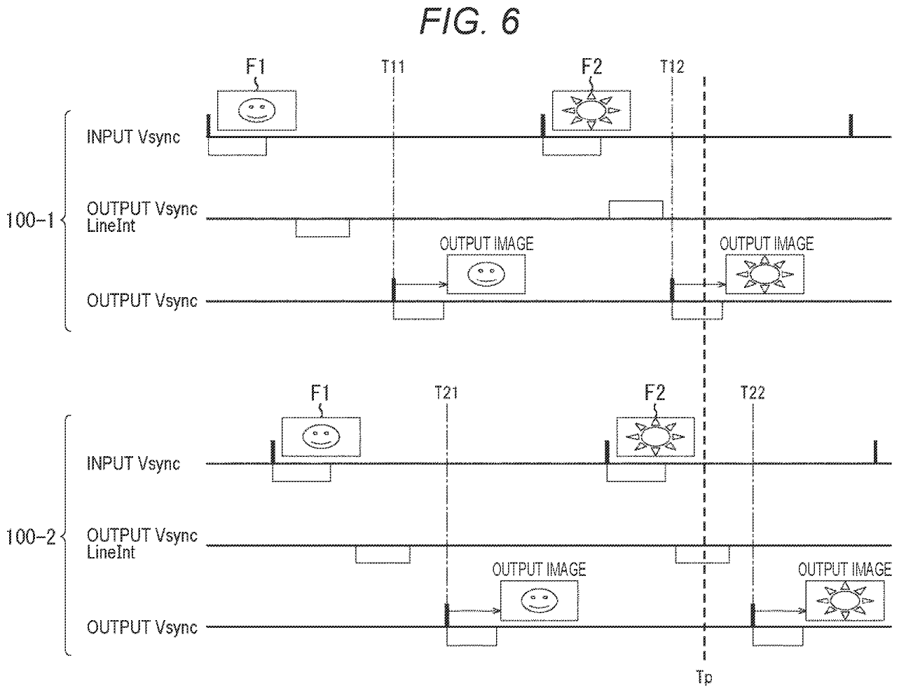

FIG. 6 is a diagram illustrating timings of respective pieces of processing executed on an image signal in the panel 100-1 and 100-2 in a case where the above-described technology for reducing the input-output delay is applied to each of the panels 100-1 and 100-2.

When the image F1 is input to the panel 100-1, an input task and an interrupt task are executed on the image F1. Then, at timing T11, an output task is executed, so that the left half of the output image corresponding to the image F1 is displayed on the panel 100-1.

Thereafter, when the image F2 is input to the panel 100-1, an input task and an interrupt task are executed on the image F2. Then, at timing T12, an output task is executed, so that the left half of the output image corresponding to the image F2 is displayed on the panel 100-1.

Similarly, when the image F1 is input to the panel 100-2, an input task and an interrupt task are executed on the image F1. Then, at timing T21, an output task is executed, so that the right half of the output image corresponding to the image F1 is displayed on the panel 100-2.

Thereafter, when the image F2 is input to the panel 100-2, an input task and an interrupt task are executed on the image F2. Then, at timing T22, an output task is executed, so that the right half of the output image corresponding to the image F2 is displayed on the panel 100-2.

In the example of FIG. 6, the panel 100-1 and the panel 100-2 separately execute the reduction of the input-output delay (the advancement of the interrupt task and the output task). However, the timing of the input Vsync and the timing of the output Vsync are different between the panel 100-1 and the panel 100-2. Thus, timing Tp at which the output image corresponding to the image F2 is displayed on the panel 100-1 is before the execution of the output task for the image F2 on the panel 100-2.

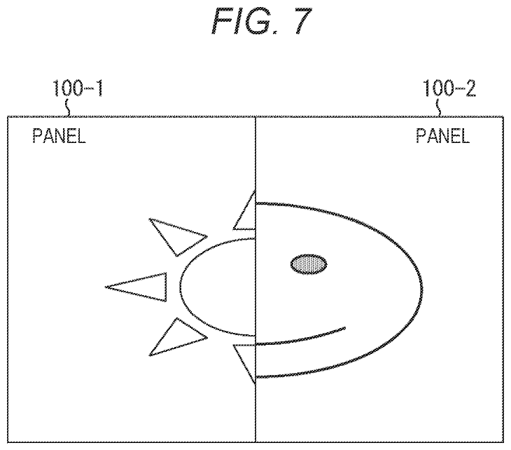

At this time, as illustrated in FIG. 7, the left half of the output image corresponding to the image F2 is displayed on the panel 100-1, while the right half of the output image corresponding to the image F1 is displayed on the panel 100-2.

As described above, in a case where the above-described technology for reducing the input-output delay is simply applied to the plurality of panels constituting the multi-display wall system, the respective output Vsyncs of the panels are not synchronized, and the displayed images are inconsistent.

Accordingly, in the technology according to the present disclosure, the respective output Vsyncs of the panels are synchronized in the plurality of panels constituting the multi-display wall system to which the technology for reducing the input-output delay is applied.

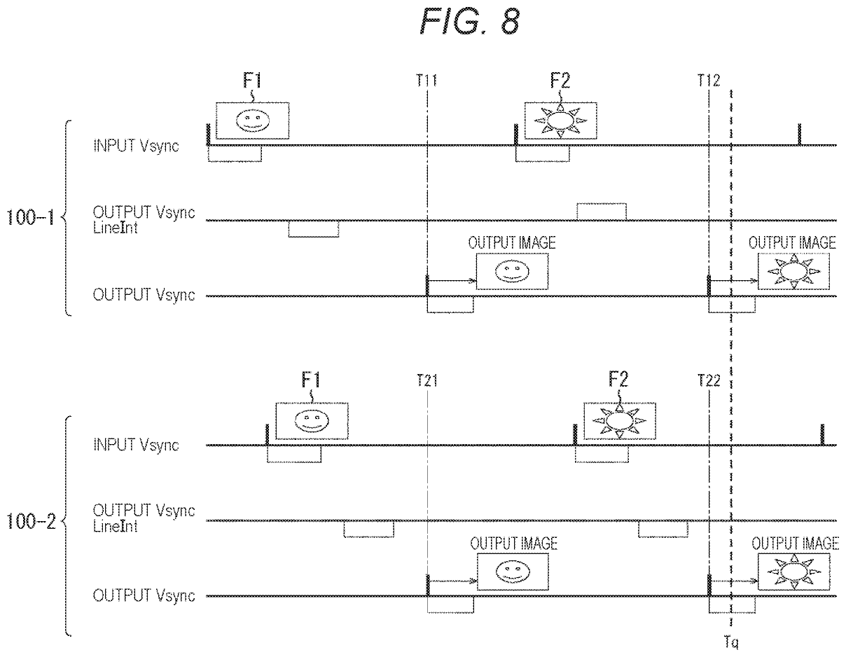

That is, as illustrated in FIG. 8, each of the panel 100-1 and the panel 100-2 individually reduces the input-output delay (advance the interrupt task), and adjust the timing of the output Vsync to the timing of the latest output Vsync in all the panels.

Specifically, the panel 100-1 matches timing T11 at which the output task for the image F1 is executed with timing T21 at which the output task for the image F1 is executed in the panel 100-2. Similarly, the panel 100-1 matches timing T12 at which the output task for the image F2 is executed with timing T22 at which the output task for the image F2 is executed in the panel 100-2.

That is, the timing at which the output image corresponding to the image F2 is displayed on each of the panels 100-1 and 100-2 can be matched with timing Tq.

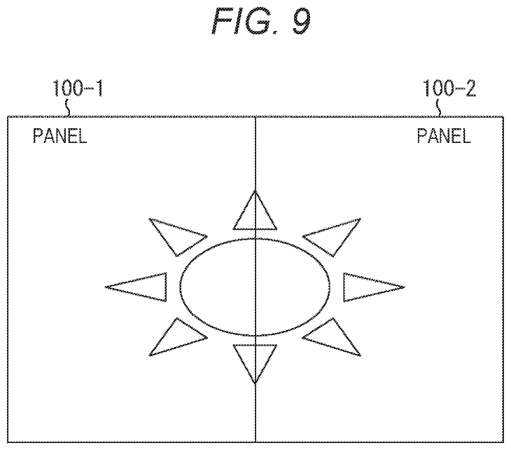

Thus, as illustrated in FIG. 9, the left half of the output image corresponding to the image F2 is displayed on the panel 100-1, and the right half of the output image corresponding to the image F2 is displayed on the panel 100-2, so that the displayed images can be prevented from being inconsistent.

<5. Configuration of Panel to which Technology According to Present Disclosure is Applied>

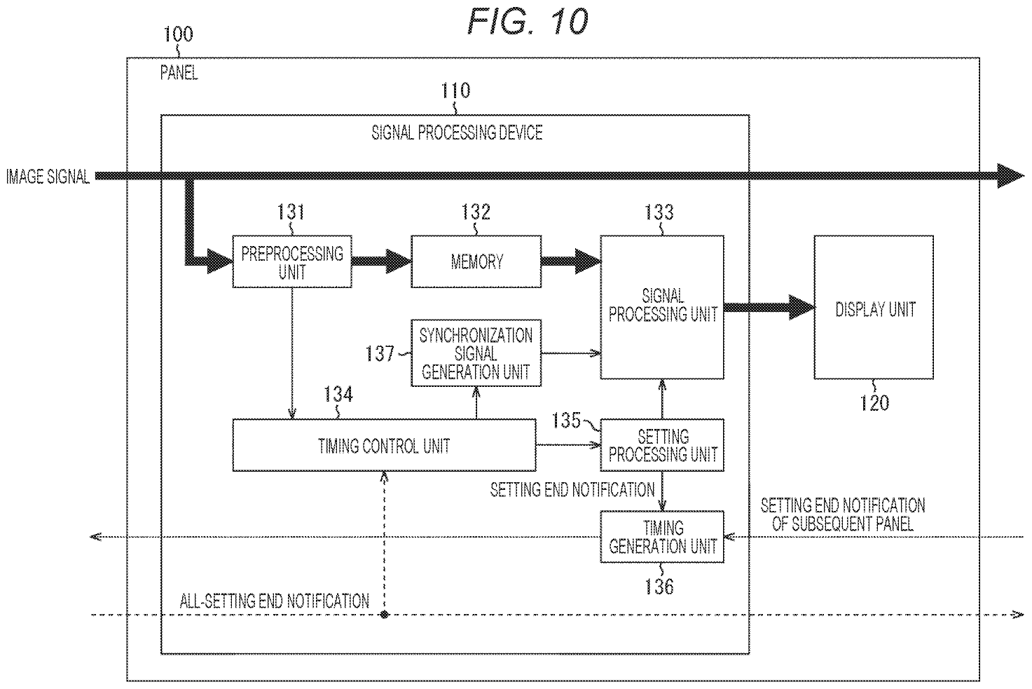

FIG. 10 is a block diagram illustrating a configuration example of a panel to which the technology according to the present disclosure is applied.

Hereinafter, in a case where the panels 100-1 to 100-4 (100-1 and 100-2) described above are not distinguished from each other, they are simply referred to as the panel 100.

The panel 100 in FIG. 10 constitutes a multi-display wall system as a display system, and includes a signal processing device 110 and a display unit 120. That is, the signal processing device 110 and the display unit 120 are provided in each of the panels 100.

The signal processing device 110 controls the operation of the panel 100 as a display device. The signal processing device 110 outputs the input image signal to the display unit 120 and supplies the image signal to the panel 100 in the subsequent stage constituting the multi-display wall system.

The display unit 120 includes a liquid crystal display, an organic electro-luminescence (EL) display, or the like, and displays an image corresponding to the image signal from the signal processing device 110. The image signal from the signal processing device 110 is an image signal corresponding to an image of a region corresponding to the arrangement of the panels 100 constituting the multi-display wall system.

The signal processing device 110 includes a preprocessing unit 131, a memory 132, a signal processing unit 133, a timing control unit 134, a setting processing unit 135, a timing generation unit 136, and a synchronization signal generation unit 137.

The preprocessing unit 131 receives the input image signal and performs preprocessing on the received image signal. The preprocessed image signal is supplied to the memory 132.

The memory 132 is configured as a frame memory, a frame buffer, a video random access memory (VRAM), or the like, and holds the preprocessed image signal in units of frames. The image signal held in the memory 132 is read by the signal processing unit 133.

The signal processing unit 133 reads the image signal held in the memory 132 on the basis of a synchronization signal from the synchronization signal generation unit 137, and executes output processing of the read image signal. Examples of the output processing executed by the signal processing unit 133 include interlace/progressive (I/P) conversion, enlargement/reduction display processing, cutout processing, colorimetry processing, image quality control processing, and the like. Furthermore, superimposition processing of superimposing an on-screen display (OSD) image on the image signal subjected to various types of processing may be performed. The image signal subjected to various types of processing is output to the display unit 120.

Although details will be described later, the timing control unit 134 performs control so as to advance start timings of some pieces of processing to be executed on the image signal. Furthermore, the timing control unit 134 controls a start timing of first processing on the image signal on the basis of the timing at which second processing (for example, the setting processing for the output processing) executed immediately before the first processing (for example, the output processing of the image signal) ends in all the panels 100.

The timing control unit 134 controls the start timing of the setting processing by the setting processing unit 135, the generation timing of the synchronization signal by the synchronization signal generation unit 137, and the like.

Specifically, the timing control unit 134 determines the start timing of the setting processing by the setting processing unit 135 by detecting the end timing of the preprocessing by the preprocessing unit 131. Furthermore, the timing control unit 134 determines the generation timing of the synchronization signal by the synchronization signal generation unit 137, that is, the start timing of the output processing of the image signal by the signal processing unit 133 on the basis of all-setting end notifications to be described later.

The setting processing unit 135 executes setting processing for output processing by the signal processing unit 133, and supplies the setting contents to the signal processing unit 133. Furthermore, the setting processing unit 135 supplies a setting end notification indicating that the setting processing is ended to the timing generation unit 136.

The timing generation unit 136 outputs the setting end notification from the setting processing unit 135 to the other panels 100. Specifically, the timing generation unit 136 outputs the setting end notification from the setting processing unit 135 to the timing generation unit 136 of the panel 100 in the preceding stage on the basis of the output timing of the setting end notification by the timing generation unit 136 of the panel 100 in the subsequent stage.

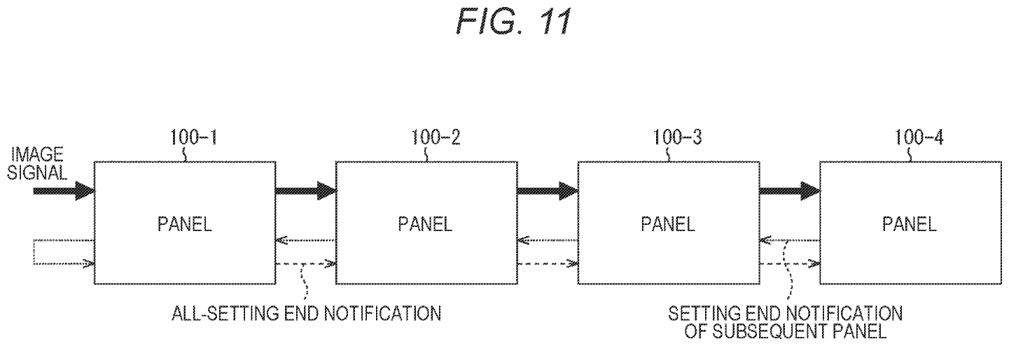

Here, a connection configuration of the panel 100 constituting the multi-display wall system will be described with reference to FIG. 11.

The panels 100-1 to 100-4 illustrated in FIG. 11 are physically arranged as described with reference to FIG. 4 to constitute the multi-display wall system.

As illustrated in FIG. 11, the panels 100-1 to 100-4 are connected in a daisy chain, and the image signal is transmitted to the panel 100-1, the panel 100-2, the panel 100-3, and the panel 100-4 in this order as described above.

The setting end notification is transmitted to the panel 100-4, the panel 100-3, the panel 100-2, and the panel 100-1 in this order via a signal line that connects the panels 100-1 to 100-4 in a daisy chain.

Specifically, the timing generation unit 136 of the panel 100-4 outputs the setting end notification from the setting processing unit 135 in the host device to the panel 100-3. The timing generation unit 136 of the panel 100-3 outputs the setting end notification from the setting processing unit 135 in the host device to the panel 100-2 by taking a logical product with the setting end notification from the panel 100-4. The timing generation unit 136 of the panel 100-2 outputs the setting end notification from the setting processing unit 135 in the host device to the panel 100-1 by taking a logical product with the setting end notification from the panel 100-3.

Then, the timing generation unit 136 of the panel 100-1 takes a logical product of the setting end notification from the setting processing unit 135 in the host device with the setting end notification from the panel 100-2, thereby generating an all-setting end notification indicating that the setting processing is ended in all the panels 100. The all-setting end notification is transmitted from the panel 100-1 to the panel 100-2, the panel 100-3, and the panel 100-4 in this order via the signal line that connects the panels 100-1 to 100-4 in a daisy chain.

That is, the all-setting end notification is input to each of the panels 100-1 to 100-4 on the basis of the output timing of the latest setting end notification in all the panels 100-1 to 100-4.

With the above configuration, in the plurality of panels constituting the multi-display wall system to which the technology of reducing the input-output delay is applied, the respective output Vsyncs of the panels can be synchronized.

### <6. Example of Timing of Each Processing Executed in Each Panel>

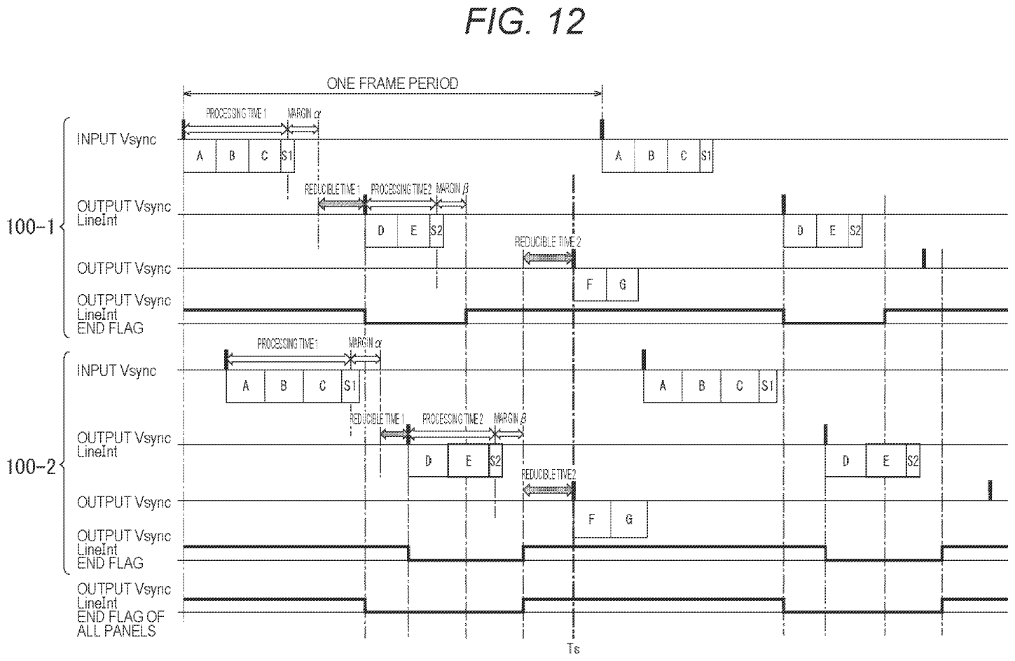

Next, an example of timing of each processing executed in each panel constituting the multi-display wall system will be described with reference to FIGS. 12 to 14.

Here, a case where the image signal is input to the multi-display wall system including the panels 100-1 and 100-2 as in FIG. 5 will be described as an example.

As illustrated in FIG. 12, in each of the panels 100-1 and 100-2, tasks A, B, and C are executed as preprocessing (input task). The input task is started at a timing based on the input Vsync.

Next, tasks D and E are executed as setting processing (interrupt task). The interrupt task is started at a timing based on the output VsyncLineInt.

Then, as output processing (output task), tasks F and G are executed. The output task is started at a timing based on the output Vsync.

With the technology according to the present disclosure, by synchronizing the respective output Vsyncs of the panels 100-1 and 100-2, the start timings of the output tasks (tasks F and G) can be matched with a timing Ts in the panel 100-1 and 100-2.

Here, the necessary time of the input tasks (tasks A, B, and C) is set to a processing time 1, and the necessary time of the interrupt tasks (tasks D and E) is set to a processing time 2. Furthermore, the time during which the interrupt task can be advanced is set to a reducible time 1, and the time during which the output tasks (tasks F and G) can be advanced is set to a reducible time 2.

The reducible time 1 is a time obtained by subtracting the margin α from the difference time from the end timing of the input task to the start timing of the interrupt task in each of the panels 100-1 and 100-2.

On the other hand, in all the panels 100-1 and 100-2, the reducible time 2 is a time obtained by subtracting the margin β from the difference time from the end timing of the interrupt task to the start timing (timing Ts) of the output task in the panel 100-2.

Specifically, an output VsyncLineInt end flag is output from each of the panels 100-1 and 100-2 as the setting end notification described above. The output VsyncLineInt end flag falls from High (H) to Low (L) at the start timings of the interrupt tasks (tasks D and E), and rises from L to H at the timing when the time corresponding to the margin β has elapsed from the end timing of the interrupt task.

Then, the output VsyncLineInt end flag of all the panels is input to each of the panels 100-1 and 100-2 as the above-described all-setting end notification. The output VsyncLineInt end flag of all panels falls from H to L when the output VsyncLineInt end flag falls from H to L in any panel 100, and rises from L to H when the output VsyncLineInt end flag rises from L to H in all panels 100.

That is, the reducible time 2 is the time from the timing when the output VsyncLineInt end flags of all the panels rise from L to H to the timing Ts.

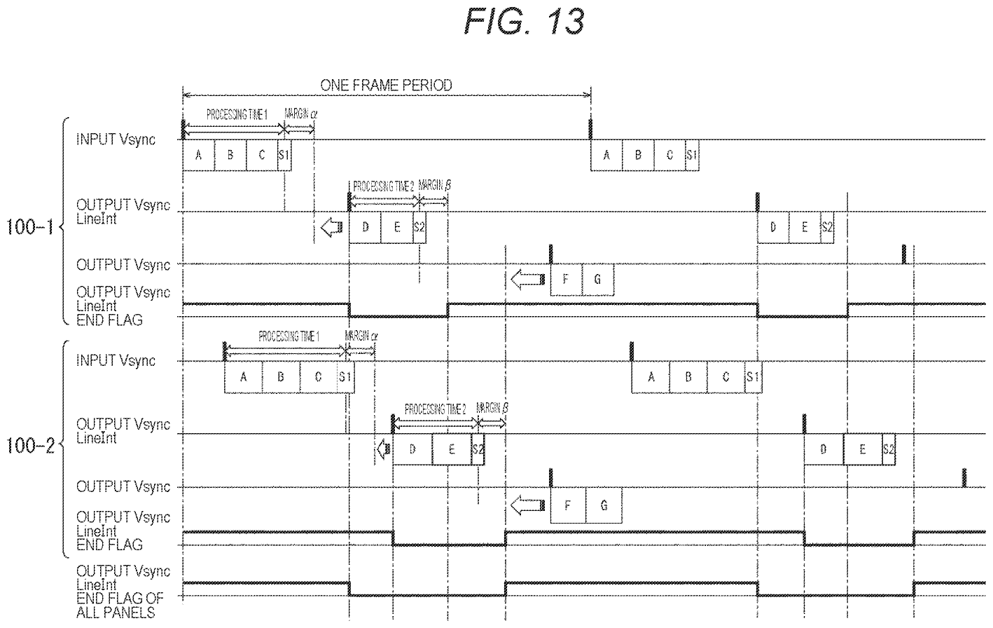

From the state of FIG. 12, with the technology according to the present disclosure, as illustrated in FIG. 13, the start timings of the interrupt tasks (tasks D and E) and the start timings of the output tasks (tasks F and G) are advanced in each of the panels 100-1 and 100-2. At this time, the start timings (output Vsync) of the output tasks (tasks F and G) in each of the panels 100-1 and 100-2 are advanced in a state of being synchronized with each other.

The advancement of the start timings of the interrupt tasks (tasks D and E) and the output tasks (tasks F and G) as illustrated in FIG. 13 is performed in stages for each frame.

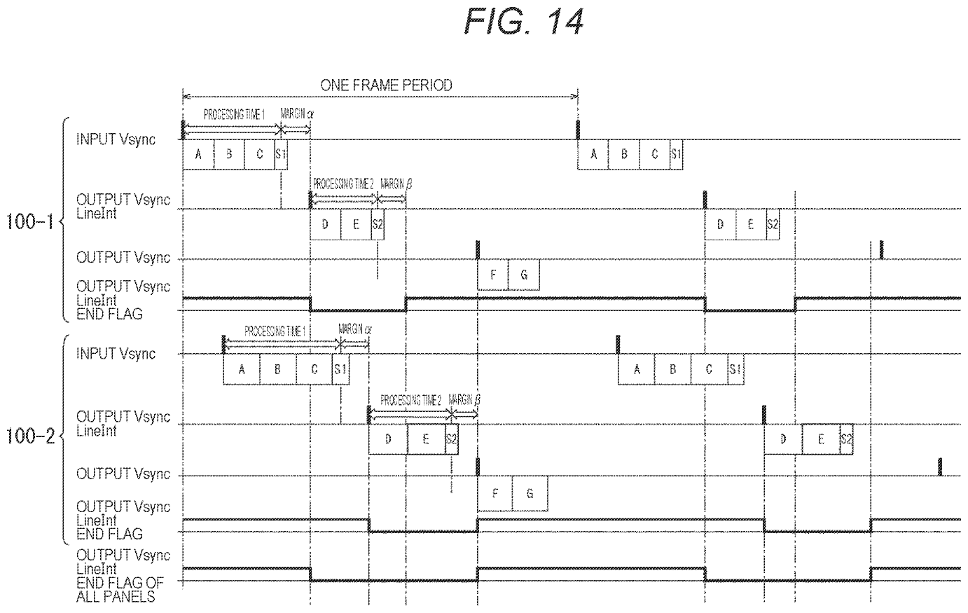

Consequently, as illustrated in FIG. 14, in each of the panels 100-1 and 100-2, the start timing of the interrupt task is advanced so that the difference time from the end timing of the input task to the start timing of the interrupt task becomes equal to the margin a. Furthermore, in each of the panels 100-1 and 100-2, the start timing of the output task is advanced so that the difference time from the end timing of the interrupt task to the start timing of the output task in the panel 100-2 becomes equal to the margin β.

According to the above operation, it is possible to implement a multi-display wall system in which display timings are synchronized while suppressing input-output delays.

The example in which the start timings of the interrupt tasks (tasks D and E) and the start timings of the output tasks (tasks F and G) are advanced from the state in which the respective output Vsyncs of the panels 100-1 and 100-2 are synchronized has been described above with reference to FIGS. 12 to 14.

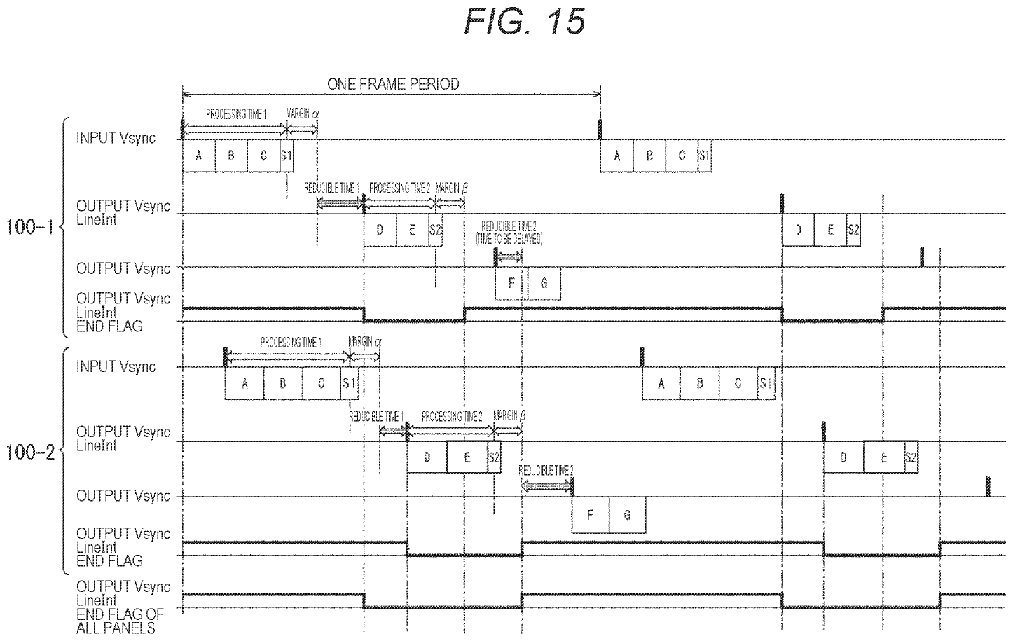

Hereinafter, an example in which the start timings of the interrupt tasks (tasks D and E) and the output tasks (tasks F and G) are advanced while synchronizing the respective output Vsyncs of the panels 100-1 and 100-2 will be described with reference to FIGS. 15 to 17.

That is, in FIG. 15, the respective output Vsyncs of the panels 100-1 and 100-2 are not synchronized. Specifically, the start timings of the output tasks (tasks F and G) in the panel 100-1 are timings before the reducible time 2 of the output tasks (tasks F and G) in the panel 100-2.

In this case, the reducible time 2 in the panel 100-1 is a time at which the start timings of the output tasks (tasks F and G) in the panel 100-1 should be delayed.

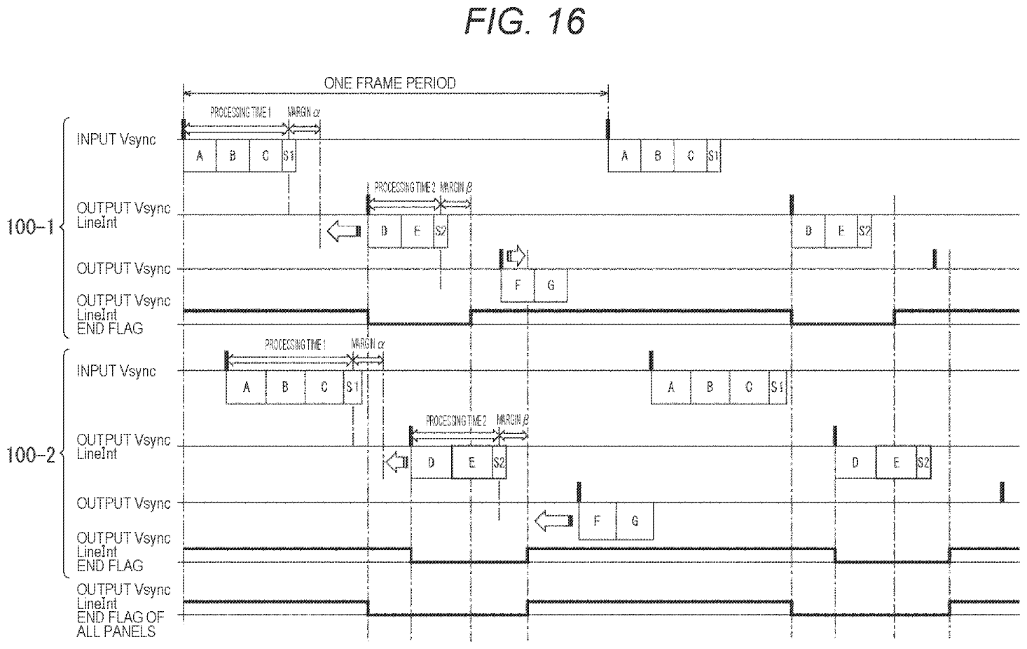

From the state of FIG. 15, with the technology according to the present disclosure, as illustrated in FIG. 16, in each of the panels 100-1 and 100-2, the start timings of the interrupt tasks (tasks D and E) and the start timings of the output tasks (tasks F and G) are advanced. Moreover, while the start timings of the output tasks (tasks F and G) in the panel 100-2 are advanced, the start timings of the output tasks (tasks F and G) in the panel 100-1 are delayed so as to be synchronized with the start timings of the output tasks (tasks F and G) in the panel 100-2.

The advancement (delay) of the start timings of the interrupt tasks (tasks D and E) and the output tasks (tasks F and G) and the synchronization of the start timings of the output tasks (tasks F and G) in each of the panels 100-1 and 100-2 as illustrated in FIG. 16 are performed stepwise for each frame.

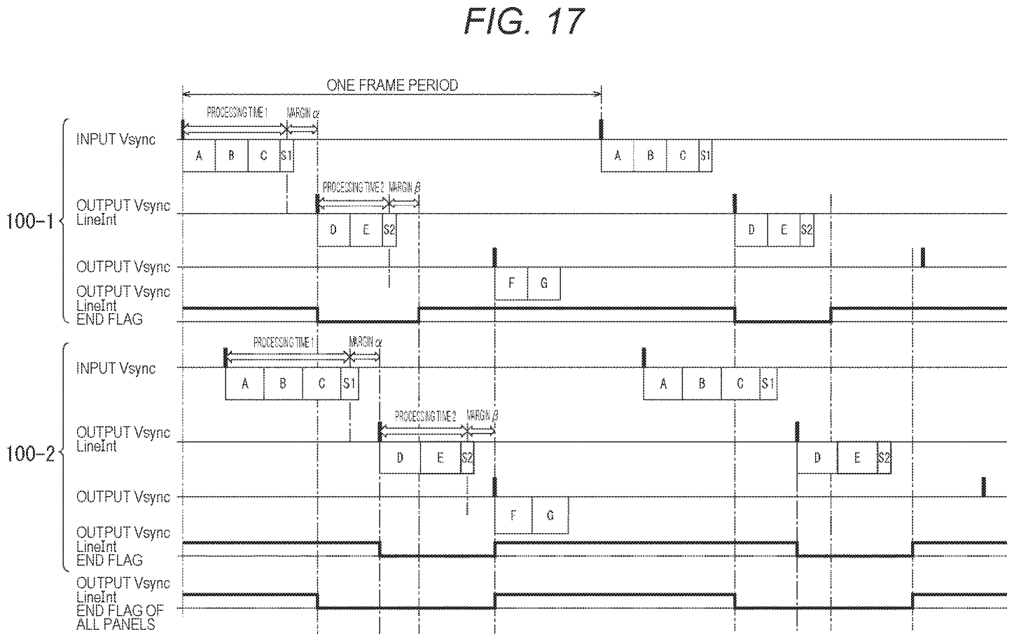

Consequently, as illustrated in FIG. 17, in each of the panels 100-1 and 100-2, the start timing of the interrupt task is advanced so that the difference time from the end timing of the input task to the start timing of the interrupt task becomes equal to the margin α. Furthermore, in each of the panels 100-1 and 100-2, while synchronizing the output Vsync, the start timing of the output task is advanced so that the difference time from the end timing of the interrupt task to the start timing of the output task in the panel 100-2 becomes equal to the margin β.

Also by the above operation, it is possible to implement the multi-display wall system in which display timings are synchronized while suppressing input-output delays.

### <7. Modification>

Hereinafter, modifications of the above-described embodiment will be described.

### (All-Setting End Notification)

In the above-described embodiment, the all-setting end notifications (the output VsyncLineInt end flags of all the panels) are signals based on the logical product of the setting end notifications (the output VsyncLineInt end flags) output from all the panels 100.

It is not limited to this, and by implementing each configuration of the signal processing device 110 by software, the all-setting end notification can be a command generated in response to the setting end notification being output in all the panels 100.

### (Reduction of Input-Output Delay)

In the above-described embodiment, the input-output delay is reduced in stages for each frame. This is an operation corresponding to following performance of processing in each panel 100.

On the other hand, in a case where there is no restriction on the following performance of processing in each panel 100, it is also possible to collectively reduce the input-output delay at a predetermined timing. In this case, in each panel 100, it is possible to prevent an unnatural image from being displayed by displaying a black screen at the timing when the input-output delay is reduced.

### (Connection Configuration of Panel)

In the embodiment described above, by connecting the respective panels in a row (connected in a daisy chain), the image signal and the all-setting end notification are sequentially transmitted to the respective panels.

It is not limited to this, and the image signal and the all-setting end notification may be directly input to each panel by connecting the respective panels in parallel.

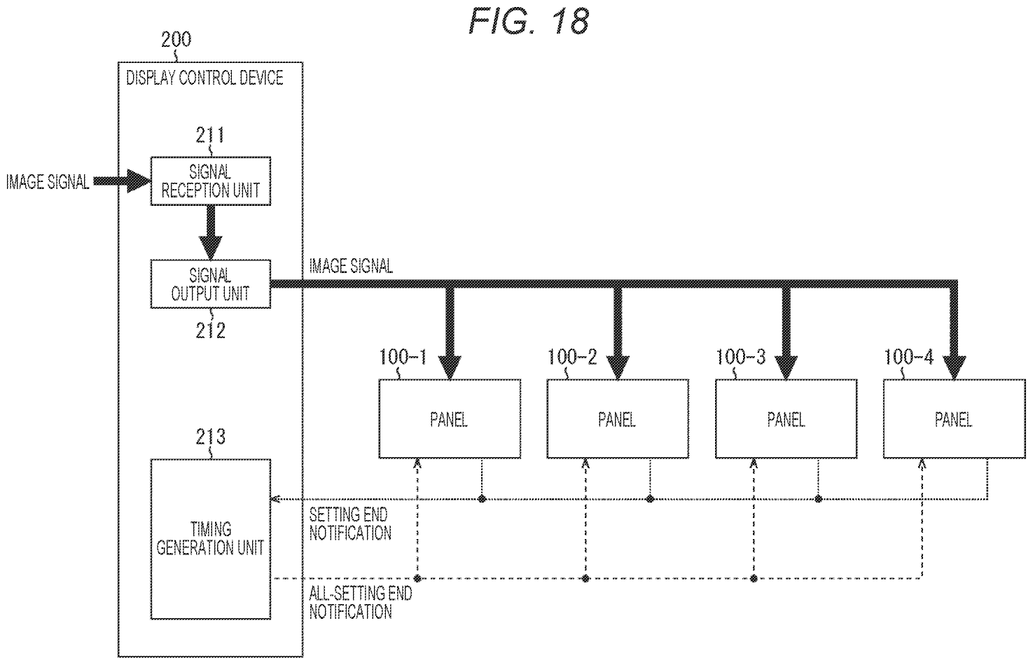

FIG. 18 is a block diagram illustrating a configuration example of a multi-display wall system in which a plurality of panels is connected in parallel.

Also in the multi-display wall system in FIG. 18, four panels 100-1 to 100-4 are arranged two vertically×two horizontally to constitute one huge display. Moreover, the multi-display wall system in FIG. 18 includes a display control device 200 in addition to the four panels 100-1 to 100-4.

In FIG. 18, the panels 100-1 to 100-4 are connected in parallel, and an image signal from the display control device 200 is input in parallel to each of the panel 100-1, the panel 100-2, the panel 100-3, and the panel 100-4.

The display control device 200 includes a signal reception unit 211, a signal output unit 212, and a timing generation unit 213.

The signal reception unit 211 includes, for example, a tuner and the like, and receives an input image signal. Here, the signal reception unit 211 may receive an image signal via a wired line or may receive an image signal via a wireless line. The received image signal is supplied to the signal output unit 212.

The signal output unit 212 outputs the image signal from the signal reception unit 211 to each of the panels 100-1 to 100-4 in parallel.

The timing generation unit 213 generates the all-setting end notification on the basis of the setting end notification from the panels 100-1 to 100-4, and inputs the all-setting end notification to each of the panels 100-1 to 100-4 in parallel.

The all-setting end notification may be generated as a signal based on the logical product of the setting end notifications output from the panels 100-1 to 100-4, or may be generated as a command according to the setting end notification being output in the panels 100-1 to 100-4.

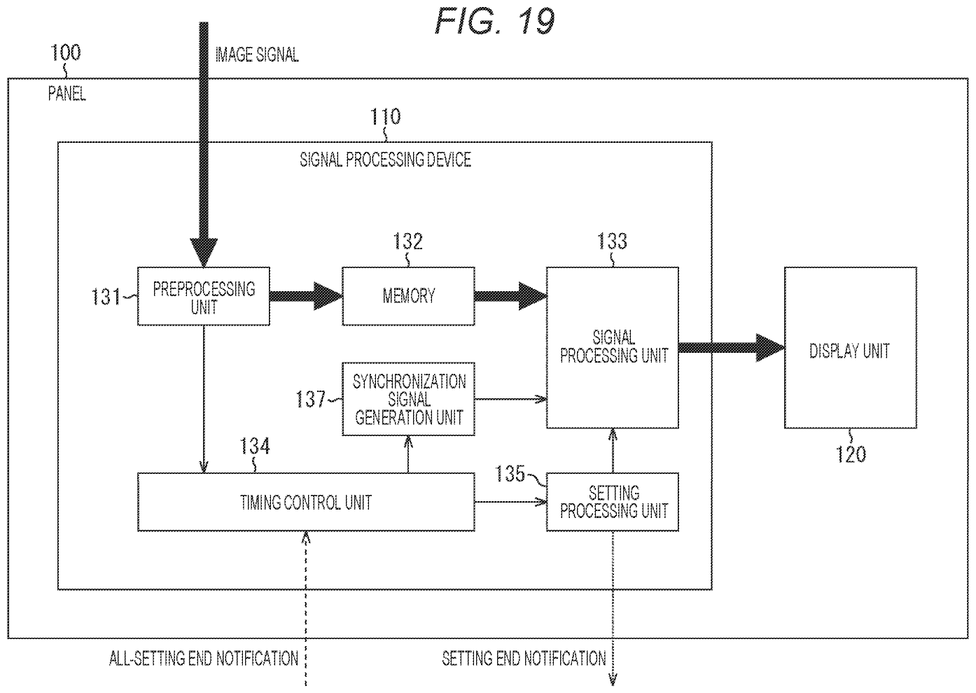

FIG. 19 is a block diagram illustrating a configuration example of the panels 100-1 to 100-4 (panel 100) constituting the multi-display wall system in FIG. 18.

The panel 100 of FIG. 19 includes the signal processing device 110 and the display unit 120 similarly to the panel 100 of FIG. 10.

The signal processing device 110 in FIG. 19 includes the preprocessing unit 131, the memory 132, the signal processing unit 133, the timing control unit 134, the setting processing unit 135, and the synchronization signal generation unit 137. That is, the signal processing device 110 of FIG. 19 is different from the panel 100 of FIG. 10 in that the timing generation unit 136 is not provided.

In the panel 100 of FIG. 19, the setting processing unit 135 supplies the setting end notification indicating that the interrupt task has ended to the timing generation unit 213 of the display control device 200. Furthermore, the timing control unit 134 determines the generation timing of the synchronization signal by the synchronization signal generation unit 137, that is, the start timing of the output task of the image signal by the signal processing unit 133 on the basis of the all-setting end notification from the timing generation unit 213 of the display control device 200.

Also with the above configuration, in the plurality of panels constituting the multi-display wall system to which the technology of reducing the input-output delay is applied, the respective output Vsyncs of the panels can be synchronized.

### (Detailed Operation of Signal Processing Device)

The signal processing device 110 can operate as follows.

The signal processing device 110 monitors the input task and the interrupt task and detects the end of the input task and the interrupt task. The signal processing device 110 may detect the start of the input task or the interrupt task as necessary. In addition, the signal processing device 110 may also monitor the output task as necessary, and detect the start or end of the output task.

For example, in a case where the signal processing device 110 is implemented by a computer, the monitoring of the input task, the interrupt task, and the output task can be implemented by using a function of an operating system (OS) started on the computer. Furthermore, it is only required to use a general method to detect the start or end of the task. For example, the detection of the start or end of the task may be performed on the basis of a specific event when the task starts or ends, or may be performed on the basis of generation or disappearance of a process corresponding to the monitored task on the OS.

Note that the processing in which the signal processing device 110 detects the end of the input task or the interrupt task also corresponds to the task in the input task or the interrupt task. Thus, the timing of detecting the end of the input task or the interrupt task is actually performed before the end of the input task or the interrupt task. For example, a task for detection is performed in parallel or periodically with another task, and the end of a task other than the task for detection is detected. Then, after the termination of the task is detected, the task for detection is terminated, and the input task is terminated.

The signal processing device 110 calculates the length of the difference time from the detected end timing of the input task to the scheduled start timing of the interrupt task. Similarly, the signal processing device 110 calculates the length of the difference time from the detected end timing of the interrupt task to the scheduled start timing of an end task. The scheduled start timing of the interrupt task or the end task may be detected as described above, or may be obtained from a predetermined fixed delay length or the end timing of the input task or the interrupt task.

The signal processing device 110 may calculate the time from the scheduled start timing of the input task to the end timing of the detected input task, that is, the necessary time of the input task. Similarly, the signal processing device 110 may calculate the time from the scheduled start timing of the interrupt task to the detected end timing of the interrupt task, that is, the necessary time of the interrupt task.

The signal processing device 110 determines whether or not to advance the scheduled start timing of the interrupt task or the output task. This determination is performed at least on the basis of the end timing of the input task or the interrupt task.

For example, the signal processing device 110 may determine whether to perform the advancement on the basis of the length of the difference time. For example, when the length of the difference time is equal to or longer than a threshold, it is determined that the advancement is performed. Furthermore, the signal processing device 110 may determine whether or not to perform the advancement on the basis of the necessary time of the input task or the interrupt task. When the necessary time of the input task or the interrupt task is equal to or less than the threshold, it is determined that the length of the difference time is sufficient and the advancement is to be performed. Since the length of the difference time and the necessary time are calculated on the basis of the end timing of the input task or the interrupt task, the determination on the basis of the length of the difference time or the necessary time can also be said to be the determination on the basis of the end timing of the input task or the interrupt task.

In addition, the signal processing device 110 may determine whether or not to perform the advancement on the basis of at least one of operation information from an operation unit (not illustrated) or image signal information acquired from an image signal. For example, in a case where an instruction to change the setting is received from the operation information or the image signal information, the signal processing device 110 may determine that the necessary time of the input task increases with the setting change, and may determine not to perform the advancement. In addition, a rule may be set in advance so that the advancement is not performed in a case where the setting change A is performed, but the advancement may be performed in a case where the setting change B is performed. Furthermore, in a case where a plurality of tasks is generated, the signal processing device 110 may add predetermined values to each of the plurality of tasks, and in a case where the sum of the values exceeds a threshold, it may be determined that execution is not performed.

The embodiments of the technology according to the present disclosure are not limited to the above-described embodiments, and various modifications can be made without departing from the scope of the technology according to the present disclosure.

Furthermore, the effects described in the present description are merely examples and are not limited, and other effects may be provided.

Moreover, the technology according to the present disclosure can have the following configurations.
(1)
A signal processing device, including:
a timing control unit that performs control so as to advance start timings of some pieces of processing to be executed on an image signal input for displaying one image by a plurality of display devices, in which
the timing control unit controls a start timing of first processing on the image signal on the basis of a timing at which second processing executed immediately before the first processing ends in all the display devices.
(2)
The signal processing device according to (1), in which
the first processing is output processing of the image signal, and
the second processing is setting processing for the output processing.
(3)
The signal processing device according to (1) or (2), in which
the signal processing device is provided in each of the display devices.
(4)
The signal processing device according to (3), in which
the timing control unit controls a start timing of the output processing on the basis of an all-setting end notification indicating that the setting processing is ended in all the display devices.
(5)
The signal processing device according to (4), further including:
a timing generation unit that outputs a setting end notification indicating that the setting processing is ended, in which
the all-setting end notification is input to each of the display devices on the basis of the output timing of the setting end notification that is latest in all the display devices.
(6)
The signal processing device according to (5), in which
the timing control unit performs control to advance the start timing of the output processing on the basis of a length of a difference time from the output timing of the setting end notification that is latest to the start timing of the output processing.
(7)
The signal processing device according to (6), in which
the timing control unit performs control to advance a start timing of the setting processing on the basis of an end timing of preprocessing on the input image signal.
(8)
The signal processing device according to (7), in which
the timing control unit performs control to advance the start timing of the setting processing on the basis of a length of a difference time from the end timing of the preprocessing to the start timing of the setting processing.
(9)
The signal processing device according to any one of (5) to (8), in which
the all-setting end notification is a signal based on a logical product of the setting end notification output in all the display devices.
(10)
The signal processing device according to any one of (5) to (8), in which
the all-setting end notification is a command generated in response to the setting end notification being output in all the display devices.
(11)
The signal processing device according to any one of (5) to (10), in which
the all-setting end notification is input to each of the display devices via a daisy chain connection.
(12)
The signal processing device according to (11), in which
the image signal is input to each of the display devices via the daisy chain connection.
(13)
The signal processing device according to any one of (5) to (10), in which
the all-setting end notification is input in parallel to each of the display devices.
(14)
The signal processing device according to (13), in which
the image signal is input in parallel to each of the display devices.
(15)
The signal processing device according to any one of (1) to (14), in which
the timing control unit performs control to advance start timings of some pieces of the processing in stages.
(16)
The signal processing device according to any one of (1) to (14), in which
the timing control unit performs control to collectively advance start timings of some pieces of the processing.
(17)
A signal processing method including, by a signal processing device:
performing control so as to advance start timings of some pieces of processing to be executed on an image signal input for displaying one image by a plurality of display devices, and
controlling a start timing of first processing on the image signal on the basis of a timing at which second processing executed immediately before the first processing ends in all the display devices.
(18)
A display system, including:
a plurality of display devices, in which
each of the display devices includes
a timing control unit that performs control so as to advance start timings of some pieces of processing to be executed on an image signal input for displaying one image by a plurality of display devices, and
the timing control unit controls a start timing of first processing on the image signal on the basis of a timing at which second processing executed immediately before the first processing ends in all the display devices.

### REFERENCE SIGNS LIST

100-1 to 100-4, 100 Panel
110 Signal processing device
120 Display unit
131 Preprocessing unit
132 Memory
133 Signal processing unit
134 Timing control unit
135 Setting processing unit
136 Timing generation unit
137 Synchronization signal generation unit
200 Display control device
211 Signal reception unit
212 Signal output unit
213 Timing generation unit

1. A signal processing device, comprising:
a timing control unit that performs control so as to advance start timings of some pieces of processing to be executed on an image signal input for displaying one image by a plurality of display devices, wherein
the timing control unit controls a start timing of first processing on the image signal on a basis of a timing at which second processing executed immediately before the first processing ends in all the display devices.

2. The signal processing device according to claim 1, wherein
the first processing is output processing of the image signal, and
the second processing is setting processing for the output processing.

3. The signal processing device according to claim 2, wherein
the signal processing device is provided in each of the display devices.

4. The signal processing device according to claim 3, wherein
the timing control unit controls a start timing of the output processing on a basis of an all-setting end notification indicating that the setting processing is ended in all the display devices.

5. The signal processing device according to claim 4, further comprising:
a timing generation unit that outputs a setting end notification indicating that the setting processing is ended, wherein
the all-setting end notification is input to each of the display devices on a basis of the output timing of the setting end notification that is latest in all the display devices.

6. The signal processing device according to claim 5, wherein
the timing control unit performs control to advance the start timing of the output processing on a basis of a length of a difference time from the output timing of the setting end notification that is latest to the start timing of the output processing.

7. The signal processing device according to claim 6, wherein
the timing control unit performs control to advance a start timing of the setting processing on a basis of an end timing of preprocessing on the input image signal.

8. The signal processing device according to claim 7, wherein
the timing control unit performs control to advance the start timing of the setting processing on a basis of a length of a difference time from the end timing of the preprocessing to the start timing of the setting processing.

9. The signal processing device according to claim 5, wherein
the all-setting end notification is a signal based on a logical product of the setting end notification output in all the display devices.

10. The signal processing device according to claim 5, wherein
the all-setting end notification is a command generated in response to the setting end notification being output in all the display devices.

11. The signal processing device according to claim 5, wherein
the all-setting end notification is input to each of the display devices via a daisy chain connection.

12. The signal processing device according to claim 11, wherein
the image signal is input to each of the display devices via the daisy chain connection.

13. The signal processing device according to claim 5, wherein
the all-setting end notification is input in parallel to each of the display devices.

14. The signal processing device according to claim 13, wherein
the image signal is input in parallel to each of the display devices.

15. The signal processing device according to claim 1, wherein
the timing control unit performs control to advance start timings of some pieces of the processing in stages.

16. The signal processing device according to claim 1, wherein
the timing control unit performs control to collectively advance start timings of some pieces of the processing.

17. A signal processing method comprising, by a signal processing device:
performing control so as to advance start timings of some pieces of processing to be executed on an image signal input for displaying one image by a plurality of display devices, and
controlling a start timing of first processing on the image signal on a basis of a timing at which second processing executed immediately before the first processing ends in all the display devices.

18. A display system, comprising:
a plurality of display devices, wherein
each of the display devices includes
a timing control unit that performs control so as to advance start timings of some pieces of processing to be executed on an image signal input for displaying one image by a plurality of display devices, and
the timing control unit controls a start timing of first processing on the image signal on a basis of a timing at which second processing executed immediately before the first processing ends in all the display devices.
